(19) United States
(12) Patent Application Publication
(10) Pub. No.: US 2013/0201887 A1
(43) Pub. Date: Aug. 8, 2013

(54) WIRELESS TERMINAL

(71) Applicant: Satoru GOTO, Nagoya-shi (JP)

(72) Inventor: Satoru GOTO, Nagoya-shi (JP)

(73) Assignee: Buffalo Inc., Nagoya-shi (JP)

(21) Appl. No.: 13/568,701

(22) Filed: Aug. 7, 2012

(30) Foreign Application Priority Data
Aug. 12, 2011 (JP) 2011-177154

(51) Int. Cl. H04W 52/02

(52) U.S. Cl. CPC H04W 52/0261
USPC 370/311

(57) ABSTRACT

A wireless terminal that includes a control unit that controls a wireless communication section of the wireless terminal to not perform uploading data to, or downloading data from, an external storage when a wireless connection is established with a wireless access point other than a wireless access point specified in advance; and controls the wireless communication section to perform the uploading or downloading via the wireless access point specified in advance when a wireless connection is established with the wireless access point specified in advance.

### CROSS-REFERENCE TO RELATED APPLICATION

This non-provisional application claims priority under 35 U.S.C. §119(a) to Patent Application No. 2011-177154 filed in Japan on Aug. 12, 2011, the entire contents of which is hereby incorporated by reference.

### FIELD OF THE INVENTION

The present disclosure relates to a wireless terminal that establishes a wireless connection with a wireless access point.

### DESCRIPTION OF RELATED ART

Wireless terminals (mobile phone, digital camera, etc.) having a function to establish wireless connection with a wireless base station of a mobile-phone network are known. In this mobile-phone network, e.g. techniques such as high speed downlink packet access (HSDPA), high speed uplink packet access (HSUPA), and long term evolution (LTE) are used.

In recent years, as such a wireless terminal, a wireless terminal having also a function to establish a wireless connection with a wireless access point configuring a wireless LAN is also known. In the wireless LAN, techniques such as IEEE 802.11a, b, g, and n are used.

Furthermore, a technique of storing data from a wireless terminal into an external storage connected to a network such as a wireless LAN is also known. For example, this kind of technique is disclosed in U.S. Pat. No. 7,702,821 and PCT Patent Publication No. WO2007/035275.

In such a wireless terminal, in the state in which a wireless connection with a wireless base station provided in a mobile-phone network is established, data can be uploaded to an external storage connected to a network via this mobile-phone network (wireless base station) and a public communication network. Furthermore, this wireless terminal establishes a wireless connection with a wireless access point connected to a LAN (hereinafter, home LAN) to which an external storage is connected. In addition, this wireless terminal uploads data to the external storage via the wireless access point connected to this home LAN. Moreover, it is also possible for this wireless terminal to establish communication with a wireless access point that is not directly connected to the home LAN (external wireless access point) and upload data to the external storage via this external wireless access point and a public communication network. Examples of the public communication network include the Internet.

However, a battery is used as the power supply of the wireless terminal in many cases. When the wireless terminal utilizes a battery, if data upload from this wireless terminal is frequently performed, the power consumption of the wireless terminal increases and the amount of battery use increases. As a result, the time during which the wireless terminal can be driven is shortened.

Meanwhile, so-called automatic upload, in which upload to an external storage is performed without artificial operation every time the data that should be uploaded is obtained, is often set. In this case, the upload is not performed unless access to the external storage can be made. However, presently, the service coverage area of the recent mobile-phone network shows a wide range and therefore upload is performed every time the data that should be uploaded is obtained as long as the mobile-phone network is available.

Furthermore, also when the mobile-phone network is not utilized, data upload is performed every time the wireless terminal is connected to a wireless access point. In particular, in recent years, the number of public wireless access points also increases and therefore upload tends to be immediately performed when the data that should be uploaded is obtained.

That is, the power consumption of the battery becomes high if the automatic upload is set.

On the other hand, if automatic upload of data to the external storage is not set, it is necessary to perform data upload to the external storage by user's operation in the state in which the wireless terminal is connectable to a wireless base station or a wireless access point, in order to effectively utilize the external storage. Thus, the convenience of the user is lowered.

### SUMMARY

One of the objects of the present disclosure is to provide a wireless terminal capable of suppressing the power consumption of the battery without lowering the convenience of the user.

A wireless terminal that includes a control unit that controls a wireless communication section of the wireless terminal to not perform uploading data to, or downloading data from, an external storage when a wireless connection is established with a wireless access point other than a wireless access point specified in advance; and controls the wireless communication section to perform the uploading or downloading via the wireless access point specified in advance when a wireless connection is established with the wireless access point specified in advance.

### BRIEF DESCRIPTION OF DRAWINGS

FIG. 1 is a schematic block diagram showing a communication system according to a first aspect of an embodiment of the present disclosure;

FIG. 2 is a block diagram showing an example of a wireless terminal according to the first aspect of the embodiment of the present disclosure;

FIG. 3 is a sequence diagram showing an operation example of the wireless terminal according to the first aspect of the embodiment of the present disclosure;

FIG. 4 is a flow diagram showing an operation example of the wireless terminal according to the first aspect of the embodiment of the present disclosure;

FIG. 5 is another flow diagram showing an operation example of the wireless terminal according to the first aspect of the embodiment of the present disclosure; and

FIG. 6 is yet another flow diagram showing an operation example of the wireless terminal according to the first aspect of the embodiment of the present disclosure.

### DESCRIPTION OF THE DISCLOSURE

A wireless terminal according to one aspect of an embodiment of the present disclosure will be described with reference to the drawings. In the following description of the drawings, parts identical to each other are given the same numeral.

It should be noted that the drawings are schematic and the ratio of the respective sizes is different from the actual ratio. Therefore, the specific sizes and so forth should be determined by taking the following description into consideration. Furthermore, it is obvious that part in which the mutual size relationship and ratio are different is included also among the drawings.

### Outline of Embodiment

The wireless terminal according to the present embodiment includes a wireless communication section that establishes a wireless connection with a wireless access point that determines whether or not to permit the wireless connection. This wireless terminal includes a control section that performs data upload to an external storage or data download from the external storage. This control section does not perform upload or download when a wireless connection is established with a wireless access point other than the wireless access point specified in advance, of wireless access points that determine whether or not to permit the wireless connection. The control section performs upload or download via the wireless access point specified in advance when a wireless connection is established with the wireless access point specified in advance.

In the present embodiment, the control section performs upload or download via the wireless access point specified in advance only when a wireless connection is established with the wireless access point specified in advance, of the wireless access points that determine whether or not to permit the wireless connection. Therefore, the opportunity for upload and download is reduced and consumption of the power of the battery can be suppressed. Furthermore, the lowering of the convenience of the user is also avoided if the wireless access point to be specified is properly selected.

For example, if the necessity for frequent data backup in a day is low, the power consumption of the battery can be suppressed without lowering the convenience of the user by specifying a wireless access point set in the home or workplace.

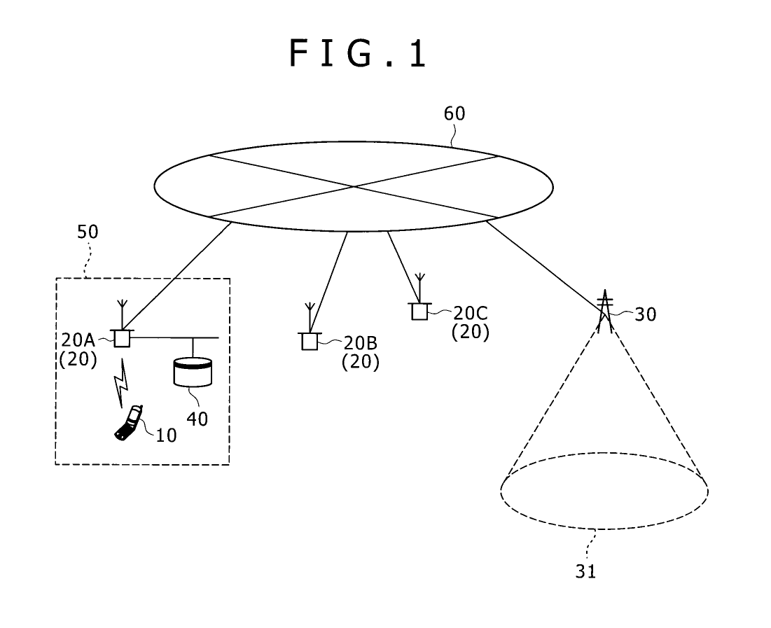

A communication system according to the first aspect of the present embodiment will be described below. FIG. 1 is a block diagram showing the communication system according to the first aspect of the present embodiment.

As shown in FIG. 1, the communication system according to the first aspect of the present embodiment includes a wireless terminal 10, wireless access points 20, a wireless base station 30, an external storage 40, a home network 50, and a wide area network 60.

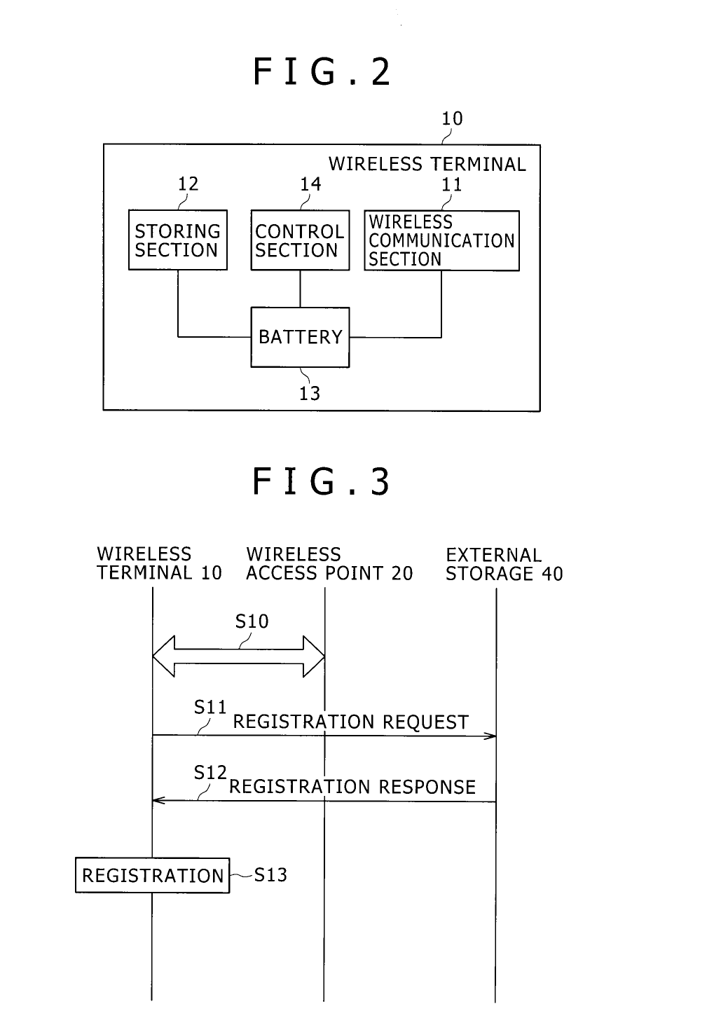

The wireless terminal 10 is e.g. a mobile phone such as a smartphone or a digital camera. This wireless terminal 10 has a function to establish a wireless connection with the wireless access point 20. Details of the wireless terminal 10 will be described later (see FIG. 2).

The wireless terminal 10 can establish a wireless connection only with the wireless access point 20 that permits the wireless connection of the wireless terminal 10. To establish the wireless connection with the wireless access point 20, various kinds of setting information such as service set identifier (SSID), security type, security key, and authentication information are necessary. For example, the wireless access point 20 in which security is set permits the wireless connection of the wireless terminal 10 in which the security type and security key of this set security are set, but rejects the wireless connection of the other wireless terminals 10. Furthermore, the wireless access point 20 may be so set as to need authentication information. In this case, the wireless access point 20 permits the wireless connection of the wireless terminal 10 in which the correct authentication information is input.

The wireless terminal 10 can detect the radio waves output from the wireless access point 20 irrespective of whether or not this wireless access point 20 permits the wireless connection of the wireless terminal 10. However, as already described, the wireless terminal 10 cannot establish a wireless connection with the wireless access point 20 that does not permit the wireless connection of the wireless terminal 10.

This wireless terminal 10 may have a function to establish a wireless connection with the wireless base station 30 set in a mobile-phone network. In general, the service cover area of the mobile-phone network is wider than that of the wireless LAN. In a certain aspect of the present embodiment, the wireless terminal 10 establishes a wireless connection with the wireless base station 30 if it cannot establish a wireless connection with the wireless access point 20.

The wireless access point 20 is e.g. an access point configuring a wireless LAN. The wireless access point 20 forms the range the radio waves output from the wireless access point 20 reach (cover area). This wireless access point 20 has a function to establish a wireless connection with the wireless terminal 10 located in the cover area. In one aspect of the embodiment of the present disclosure, a wireless access point 20A, a wireless access point 20B, and a wireless access point 20C are provided as the wireless access points 20.

In this example, it is assumed that the wireless access point 20A configures an in-house wireless LAN in a home or the like, has also a router function, and is connected to the wide area network 60. Furthermore, it is assumed that the wireless access point 20B and the wireless access point 20C configure a wireless LAN other than the in-house wireless LAN (e.g. public wireless LAN) and are connected to the wide area network 60.

In this example, it is assumed that the wireless access point 20A and the wireless access point 20B are the wireless access points 20 that permit the wireless connection of the wireless terminal 10. Furthermore, it is assumed that the wireless access point 20C is the wireless access point 20 that does not permit the wireless connection of the wireless terminal 10.

In a certain example of one aspect of the present embodiment, the wireless access point 20A may be the wireless access point 20 in which security is set and the wireless access point 20B may be the wireless access point 20 for which security and authentication information are unnecessary.

The wireless base station 30 forms the range the radio waves output from the wireless base station 30 reach (cover area 31). This wireless base station 30 has a function to establish a wireless connection with the wireless terminal 10 located in the cover area 31.

The external storage 40 is e.g. a network attached storage (NAS), a personal computer, or a web server. In one aspect of the embodiment of the present disclosure, this external storage 40 is connected to a wiring port of the wireless access point 20A via a network cable. The home network 50 is configured by the wireless LAN made by the wireless access point 20A and the wired LAN existing on the wiring port side of the wireless access point 20A. The wireless terminal 10 can access the home network 50 via the wireless access point 20A.

The home network 50 is e.g. a network in the home or workplace of the user. This home network 50 is made by the wireless access point 20 configuring an in-house wireless LAN (wireless access point 20A, in one aspect of the embodiment of the present disclosure).

The wide area network 60 is e.g. the Internet, which relays communication based on a protocol such as the TCP/IP. Various web servers are connected to the wide area network 60.

### (Wireless Terminal)

The wireless terminal 10 according to the first aspect of the embodiment of the present disclosure will be described below. FIG. 2 is a block diagram showing an example of the wireless terminal 10 according to the first aspect of the embodiment of the present disclosure.

As shown in FIG. 2, the wireless terminal 10 has a wireless communication section 11, a storing section 12, a battery 13, and a control section 14.

The wireless communication section 11 includes an antenna and a wireless module. This wireless communication section 11 detects the radio waves output from the wireless access point 20 and establishes a wireless connection with the wireless access point 20 that permits the wireless connection of the wireless terminal 10. The wireless communication section 11 may have a function to detect the radio waves output from the wireless base station 30 and establish a wireless connection with the wireless base station 30.

The storing section 12 is a memory device, a disc device, etc. and stores data for controlling the wireless terminal 10 (program, application, etc.) and user data of documents, photographs, etc.

The battery 13 is e.g. a cell pack that supplies power to the wireless terminal 10. Specifically, the battery 13 supplies power to the wireless communication section 11, the storing section 12, and the control section 14.

The control section 14 controls the wireless terminal 10. For example, the control section 14 controls functions of web browsing, mail acquisition, data upload, data download, etc.

In one aspect of the embodiment of the present disclosure, the control section 14 is a program control device such as a CPU and executes processing of registering the external storage 40 as the counterpart device with which upload or download is performed via the wireless access point 20 that permits the wireless connection of the wireless terminal 10.

In this registration processing of the external storage 40, reference information (e.g. path name) to specify a folder in the storing section 12 is registered as the storing location in which the data that should be uploaded is stored, and reference information (e.g. URL) to specify a folder in the external storage 40 is registered as the storing location to which the data should be uploaded. These registered pieces of reference information are retained in the storing section 12.

Furthermore, in this registration processing of the external storage 40, reference information (e.g. URL) to specify a folder in the external storage 40 is registered as the storing location in which the data that should be downloaded is stored, and reference information (e.g. path name) to specify a folder in the storing section 12 is registered as the location in which downloaded data is stored. These registered pieces of reference information are retained in the storing section 12.

The control section 14 uploads, to the registered storing location in the external storage 40, the data stored in the folder in the storing section 12 represented by the reference information registered as the storing location in which the data that should be uploaded is stored. Alternatively, the control section 14 downloads, from the specified folder in the storing section 12, the data stored in the registered storing location in the external storage 40.

In one aspect of the present embodiment, this control section 14 performs data upload to the external storage 40 or data download from the external storage 40 without artificial operation when a wireless connection is established with the wireless access point 20 specified in advance, of the wireless access points 20 that permit the wireless connection of the wireless terminal 10. On the other hand, the control section 14 does not perform data upload to the external storage 40 or data download from the external storage 40 without artificial operation when a wireless connection is established with the wireless access point 20 other than the wireless access point 20 specified in advance, of the wireless access points 20 that permit the wireless connection of the wireless terminal 10.

The wireless access point 20 specified in advance is part of the wireless access points 20 that permit the wireless connection of the wireless terminal 10. In one aspect of the embodiment of the present disclosure, for example the wireless access point 20 specified in advance is the wireless access point 20A, out of the wireless access point 20A, the wireless access point 20B, and the wireless access point 20C.

It is obvious that, when a wireless connection is established with the wireless access point 20 that permits the wireless connection of the wireless terminal 10, the control section 14 can carry out web access, mail acquisition, etc. via this wireless connection.

Furthermore, even when a wireless connection is established with the wireless access point 20 other than the wireless access point 20 specified in advance, the control section 14 may perform data upload to the external storage 40 or data download from the external storage 40 if upload or download is expressly ordered from the user.

If the wireless terminal 10 has the function to establish a wireless connection with the wireless base station 30, the following configuration may be employed. Specifically, the control section 14 does not automatically perform data upload to the external storage 40 or data download from the external storage 40 when wireless connection is established with the wireless base station 30. However, even when wireless connection is established with the wireless base station 30, the control section 14 may automatically perform data upload to the external storage 40 or data download from the external storage 40 if upload or download is expressly ordered from the user.

In one aspect of the embodiment of the present disclosure, the specified wireless access point 20 may be the wireless access point 20 set in the home network 50 to which the external storage 40 is connected. For example, in the case shown in FIG. 1, the specified wireless access point 20 is the wireless access point 20A.

In one aspect of the present embodiment, the specified wireless access point 20 may be the wireless access point 20 connected when the procedure of registering the external storage 40 is carried out. For example, in the case shown in FIG. 1, if the wireless terminal 10 is connected to the wireless access point 20A when the procedure of registering the external storage 40 is carried out, the wireless access point 20A is employed as the specified wireless access point 20. In such a case, when a wireless connection is established with the wireless access point 20B, which is not specified, data upload to the external storage 40 or data download from the external storage 40 is not automatically performed.

The following configuration may be employed. Specifically, the control section 14 performs upload or download via the specified wireless access point 20 if the power stored in the battery 13 is equal to or higher than a predetermined threshold. In other words, even when a wireless connection is established with the specified wireless access point 20, the control section 14 may limit upload or download if the power stored in the battery 13 is lower than the predetermined threshold.

The control section 14 may stop upload or download if a wireless connection established with the specified wireless access point 20 is disconnected. For example, in the case shown in FIG. 1, if the specified wireless access point 20 is the wireless access point 20A, upload or download is stopped when the wireless terminal 10 gets away from the home network and gets out of the state in which a wireless connection is established with the wireless access point 20A. For example, upload or download is stopped when state transition occurs from the state in which a wireless connection is established with the wireless access point 20A to the state in which a wireless connection is established with the wireless base station 30.

### (Operation of Wireless Terminal)

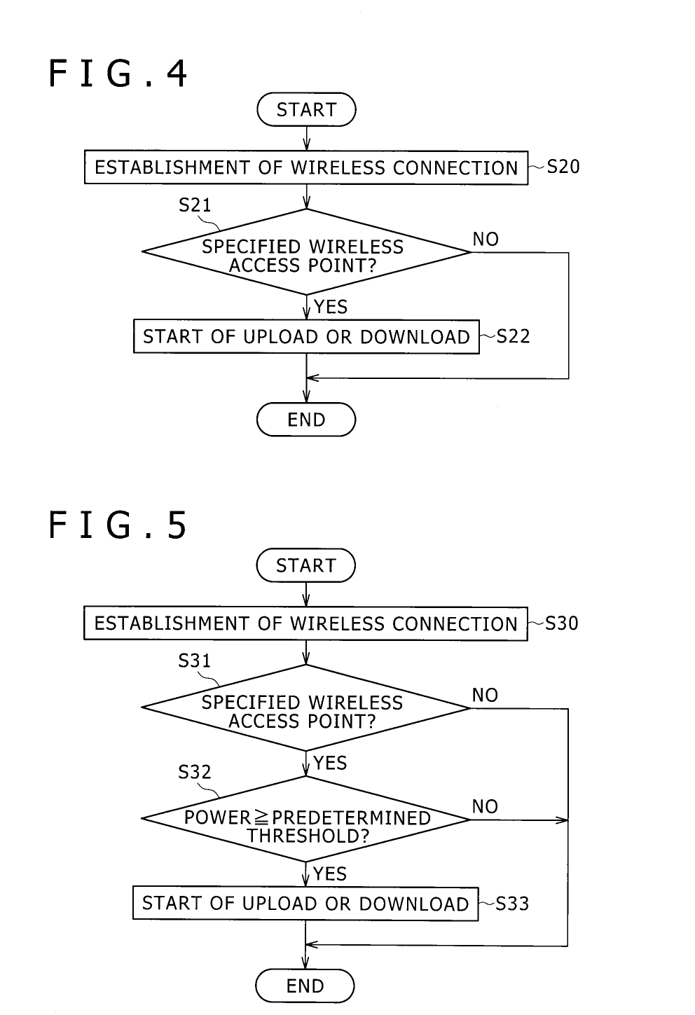

The operation of the wireless terminal according to one aspect of the embodiment of the present disclosure will be described below. FIG. 3 is a sequence diagram showing the operation of the wireless terminal 10 according to one aspect of the embodiment of the present disclosure. FIG. 4 to FIG. 6 are flow diagrams showing the operation of the wireless terminal 10 according to one aspect of the embodiment of the present disclosure.

In the following, exemplification will be made about the case in which the specified wireless access point 20 is the wireless access point 20 connected when the procedure of registering the external storage 40 is carried out.

### (Registration Procedure)

First, the registration procedure (setup procedure) of the external storage 40 will be described with reference to FIG. 3.

As shown in FIG. 3, in a step S10, a wireless connection is established between the wireless terminal 10 and the wireless access point 20.

In a step S11, the wireless terminal 10 transmits a registration request of the external storage 40 to the external storage 40. For example, the registration request includes the following pieces of information: information to specify the folder in which the data that should be uploaded is stored (information to specify a folder in the storing section 12); information (it may be URL) to specify the folder in the external storage 40 to which data should be uploaded; information (it also may be URL) to specify the folder in the external storage 40 in which the data that should be downloaded is stored; and information to specify the folder in the storing section 12 as the location in which downloaded data is stored.

In a step S12, the external storage 40 transmits a registration response of the external storage 40 to the wireless terminal 10.

In a step S13, the wireless terminal 10 completes the registration procedure of the external storage 40. In this step, the wireless terminal 10 stores information that specifies the wireless access point 20 connected when the procedure of registering the external storage 40 (steps S11 and S12) is carried out as the specified wireless access point 20. For example, the wireless terminal 10 stores, in the storing section 12, an identifier (e.g. SSID) of the wireless access point 20 connected when the procedure of registering the external storage 40 is carried out.

### (Procedure 1 of Start of Upload/Download)

Next, procedure 1 of start of upload/download will be described below with reference to FIG. 4.

As shown in FIG. 4, in a step S20, the wireless terminal 10 establishes a wireless connection with the wireless access point 20.

In a step S21, the wireless terminal 10 determines whether or not the wireless access point 20 with which the wireless connection is established is the specified wireless access point 20. If the wireless access point 20 with which the wireless connection is established is the specified wireless access point 20, the wireless terminal 10 moves to processing of a step S22. If the wireless access point 20 with which the wireless connection is established is not the specified wireless access point 20, the wireless terminal 10 ends the series of processing.

In the step S22, the wireless terminal 10 starts data upload to the registered external storage 40. Alternatively, the wireless terminal 10 starts data download from the registered external storage 40.

It is obvious that the wireless terminal 10 can carry out web access, mail acquisition, etc. if a wireless connection is established with the wireless access point 20 irrespective of whether or not the wireless access point 20 is the specified wireless access point 20.

### (Procedure 2 of Start of Upload/Download)

Furthermore, procedure 2 of start of upload/download will be described below with reference to FIG. 5.

As shown in FIG. 5, in a step S30, the wireless terminal 10 establishes a wireless connection with the wireless access point 20.

In a step S31, the wireless terminal 10 determines whether or not the wireless access point 20 with which the wireless connection is established is the specified wireless access point 20. If the wireless access point 20 with which the wireless connection is established is the specified wireless access point 20, the wireless terminal 10 moves to processing of a step S32. If the wireless access point 20 with which the wireless connection is established is not the specified wireless access point 20, the wireless terminal 10 ends the series of processing.

In the step S32, the wireless terminal 10 determines whether or not the power stored in the battery 13 is equal to or higher than a predetermined threshold. If the power stored in the battery 13 is equal to or higher than the predetermined threshold, the wireless terminal 10 moves to processing of a step S33. If the power stored in the battery 13 is lower than the predetermined threshold, the wireless terminal 10 ends the series of processing.

In the step S33, the wireless terminal 10 starts data upload to the registered external storage 40. Alternatively, the wireless terminal 10 starts data download from the registered external storage 40.

It is obvious that the wireless terminal 10 can carry out web access, mail acquisition, etc. if a wireless connection is established with the wireless access point 20 irrespective of whether or not the wireless access point 20 is the specified wireless access point 20.

### (Procedure of Stop of Upload/Download)

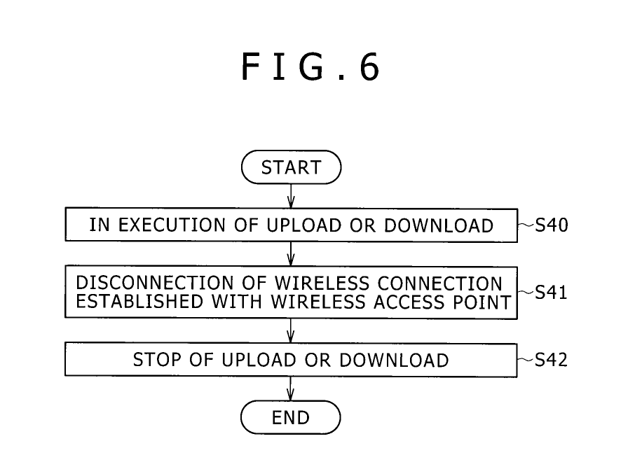

Next, the procedure of stop of upload/download will be described below with reference to FIG. 6. FIG. 6 is based on the premise that a wireless connection is established between the specified wireless access point 20 and the wireless terminal 10.

As shown in FIG. 6, in a step S40, the wireless terminal 10 is executing data upload to the registered external storage 40. Alternatively, the wireless terminal 10 is executing data download from the registered external storage 40.

In a step S41, the wireless connection established with the specified wireless access point 20 is disconnected.

In a step S42, the wireless terminal 10 stops the data upload to the registered external storage 40. Alternatively, the wireless terminal 10 stops the data download from the registered external storage 40.

For example, the upload or download is stopped when the wireless terminal 10 gets away from the cover area of the specified wireless access point 20. Furthermore, the upload or download is stopped also when state transition occurs from the state in which the wireless connection is established with the specified wireless access point 20 to the state in which a wireless connection is established with the wireless base station 30.

In one aspect of the embodiment of the present disclosure, the control section 14 performs upload or download via the wireless access point 20 specified in advance only when a wireless connection is established with the wireless access point 20 specified in advance, of the wireless access points 20 that permit the wireless connection. Therefore, the opportunity for upload and download can be reduced and consumption of the power stored in the battery 13 can be suppressed. Furthermore, the lowering of the convenience of the user is also avoided if the wireless access point 20 specified in advance is properly selected.

Examples of the wireless access point 20 that permits the wireless connection will include the wireless access point 20 configuring a public wireless LAN set in a facility such as a shop and a station. If there is a history of establishment of a wireless connection with the wireless access point 20 configuring such a public wireless LAN, the wireless terminal 10 will establish a wireless connection with the wireless access point 20 configuring this public wireless LAN without artificial operation. When a wireless connection is established with the wireless access point 20 configuring a public wireless LAN without artificial operation in this manner, the number of times of data upload and download increases if even data upload and download to and from the external storage 40 are performed without artificial operation.

Furthermore, in the case in which the wireless terminal 10 is moving, the possibility that the reception state of the radio waves output from the wireless access point 20 configuring the public wireless LAN is unstable is high. If upload or download is performed under the environment in which the reception state of the radio waves is unstable in this manner, the power stored in the battery 13 is unnecessarily consumed.

In one aspect of the embodiment of the present disclosure, as described above, only when a wireless connection is established with the wireless access point 20 specified in advance, upload or download is performed via this specified wireless access point 20. Thus, consumption of the power stored in the battery 13 can be suppressed without lowering the convenience of the user.

In one aspect of the embodiment of the present disclosure, the wireless access point 20 specified in advance may be the wireless access point 20 set in the home network 50 to which the external storage 40 is connected. When such a wireless access point 20 is specified, it is assumed that the setting place of this specified wireless access point 20 is the home or workplace. In such a place, charge of the wireless terminal 10 is easy in many cases. Furthermore, the radio wave condition of the wireless access point 20 is stable in many cases. Therefore, upload or download is permitted without the lowering of the convenience of the user.

In one aspect of the embodiment of the present disclosure, the wireless access point 20 specified in advance may be the wireless access point 20 connected when the procedure of registering the external storage 40 is carried out. The setting place of the wireless access point 20 connected when the procedure of registering the external storage 40 is carried out will be the home or workplace in many cases. In such a place, charge of the wireless terminal 10 is easy in many cases. Furthermore, the radio wave condition of the wireless access point 20 is stable in many cases. Therefore, upload or download is permitted without the lowering of the convenience of the user.

In one aspect of the embodiment of the present disclosure, the following configuration may be employed. Specifically, upload or download is performed via the specified wireless access point 20 if the power stored in the battery 13 is equal to or higher than a predetermined threshold. This suppresses the situation that the power stored in the battery 13 decreases attributed to upload or download and the wireless terminal 10 fails.

In one aspect of the embodiment of the present disclosure, upload or download may be stopped if a wireless connection with the wireless access point 20 specified in advance is disconnected. For example, upload or download may be stopped also when state transition occurs from the state in which a wireless connection is established with the wireless access point 20 specified in advance to the state in which a wireless connection is established with the wireless access point 20 other than this specified wireless access point 20 or the wireless base station 30. This suppresses the situation that upload or download is continued via a path that is not intended for use by the user and the power stored in the battery 13 is consumed.

### Other Embodiments

It should not be understood that the description and drawings as part of this disclosure limit this disclosure. From this disclosure, various alternative embodiments, working examples, and operational techniques will be apparent for those skilled in the art.

For example, the wireless access point 20 connected when the procedure of registering the external storage 40 is carried out may be limited to the wireless access point 20 set in the home network 50 to which the external storage 40 is connected.

Furthermore, the following configuration may be employed. Specifically, the wireless terminal 10 performs upload or download if the intensity of the received radio waves from the specified wireless access point 20 is equal to or higher than a predetermined threshold.

In addition, the following configuration may be employed. Specifically, the wireless terminal 10 performs upload or download if the time when the strength of the received signals from the wireless access point 20 specified in advance is equal to or higher than a predetermined threshold is equal to or longer than a predetermined time. Alternatively, the following configuration may be employed because wireless connection is unstable immediately after the wireless access point 20 that permits a connection is detected. Specifically, the wireless terminal 10 counts the elapsed time from the detection and performs upload or download without receiving artificial operation when this elapsed time surpasses a threshold determined in advance and if a connection with the wireless access point 20 is established and the wireless access point 20 with which this connection is established is one specified in advance.

Moreover, when being connected to an AC power supply, the wireless terminal 10 may perform upload or download irrespective of the power stored in the battery 13.

Furthermore, it is obvious that the wireless terminal 10 may stop upload or download if a wireless connection established with the wireless access point 20 specified in advance is disconnected.

In the disclosure made thus far, explanation is made mainly about upload or download. However, the above-described operation may be applied to synchronization of data. Specifically, the wireless terminal 10 may execute synchronization processing of data between the wireless terminal 10 and the external storage 40 only when a wireless connection is established with the wireless access point 20 specified in advance.

A program for causing a computer to carry out the above-described operation of the wireless terminal 10 may be provided. Such a program may be provided in such a state as to be stored in a recording medium such as a DVD-ROM or a CD-ROM or may be provided via a network such as the Internet.

What is claimed is:

1. A wireless terminal comprising:
a wireless communication section that establishes a wireless connection with a wireless access point; and
a control section that controls the wireless communication section to not perform uploading data to, or downloading data from, an external storage when a wireless connection is established with a wireless access point other than a wireless access point specified in advance, and controls the wireless communication section to perform the uploading or downloading via the wireless access point specified in advance when a wireless connection is established with the wireless access point specified in advance.

2. The wireless terminal of claim 1, further comprising:
a storing section that stores identification information corresponding to the wireless access point specified in advance.

3. The wireless terminal of claim 2, wherein
the control section acquires the identification information corresponding to the wireless access point specified in advance from the storing section and controls the wireless communication section on the basis of the acquired identification information.

4. The wireless terminal of claim 1, wherein
the wireless access point specified in advance is connected to a same local network to which the external storage is connected.

5. The wireless terminal of claim 1, wherein
the control section controls a procedure of registering the external storage as a counterpart device with which the uploading or downloading is performed.

6. The wireless terminal of claim 5, wherein
the registering includes registering reference information corresponding to a storage location within the external storage to which data is uploaded to, or from which data is downloaded.

7. The wireless terminal of claim 6, wherein
the reference information includes at least one of a path name and a uniform resource locator (URL) corresponding to a storage folder of the external storage.

8. The wireless terminal of claim 5, wherein
the wireless access point specified in advance is a wireless access point to which the wireless terminal is connected when the procedure of registering the external storage is performed.

9. The wireless terminal of claim 1, further comprising:
a battery that provides power to the wireless terminal, wherein
the control section controls the wireless communication section to perform the uploading or downloading based on amount of power stored in the battery.

10. The wireless terminal of claim 9, wherein
the control section compares the amount of power stored in the battery to a predetermined threshold value.

11. The wireless terminal of claim 10, wherein
the control section controls the wireless communication section to perform the uploading or downloading via the wireless access point specified in advance when a wireless connection is established with the wireless access point specified in advance and the amount of power stored in the battery is equal to or higher than the predetermined threshold value.

12. The wireless terminal of claim 10, wherein
the control section controls the wireless communication section to not perform the uploading or downloading via the wireless access point specified in advance when a wireless connection is established with the wireless access point specified in advance and the amount of power stored in the battery is less than the predetermined threshold value.

13. The wireless terminal of claim 1, wherein
the control section controls the wireless communication to stop an in-progress uploading or downloading if a wireless connection established with the wireless access point specified in advance is disconnected.

14. The wireless terminal of claim 1, wherein
the control section compares a communication quality parameter corresponding to a signal received from the wireless access point specified in advance when a wireless connection is established with the wireless access point specified in advance to a predetermined threshold value.

15. The wireless terminal of claim 14, wherein
the control section controls the wireless communication section to perform the uploading or downloading via the wireless access point specified in advance when a wireless connection is established with the wireless access point specified in advance and the communication quality parameter is equal to or higher than the predetermined threshold value.

16. The wireless terminal of claim 14, wherein
the control section controls the wireless communication section to not perform the uploading or downloading via the wireless access point specified in advance when a wireless connection is established with the wireless access point specified in advance and the communication quality parameter is less than the predetermined threshold value.

17. A method performed by a wireless terminal, the method comprising:
controlling, by a processor of the wireless terminal, a wireless communication section of the wireless terminal to not perform uploading data to, or downloading data from, an external storage when a wireless connection is established with a wireless access point other than a wireless access point specified in advance; and
controlling, by the processor, the wireless communication section to perform the uploading or downloading via the wireless access point specified in advance when a wireless connection is established with the wireless access point specified in advance.

18. A non-transitory computer-readable medium including computer program instructions, which when executed by a wireless terminal, cause the wireless terminal to perform a method comprising:
controlling a wireless communication section of the wireless terminal to not perform uploading data to, or downloading data from, an external storage when a wireless connection is established with a wireless access point other than a wireless access point specified in advance; and
controlling the wireless communication section to perform the uploading or downloading via the wireless access point specified in advance when a wireless connection is established with the wireless access point specified in advance.
